(19) United States
(12) Patent Application Publication
(10) Pub. No.: US 2010/0078510 A1
(43) Pub. Date: Apr. 1, 2010

(54) WASTE COMMINUTING DEVICE

(75) Inventors: Patrick Le Rolland, Montbeton (FR); Christophe Garcia, Les Issards (FR); Laurent Galinier, Muret (FR)

Correspondence Address: YOUNG & THOMPSON, 209 Madison Street, Suite 500, Alexandria, VA, 22314, US

(73) Assignee: PRECIMECA, Blagnac (FR)

(21) Appl. No.: 12/514,665

(22) PCT Filed: Nov. 16, 2007
(86) PCT No.: PCT/FR2007/001885

§ 371 Date: May 13, 2009

(30) Foreign Application Priority Data
Nov. 17, 2006 (FR) 0610067

(51) Int. Cl. B02C 18/14; B02C 18/18

(52) U.S. Cl. 241/30; 241/27; 241/220; 241/243

(57) ABSTRACT

A waste comminuting device includes a comminuting housing (1), a rotor (2) provided with a plurality of protruding peripheral knives, stationary counterblades supported by the comminuting housing, the minimal distance separating each knife from each associated counterblade, during the passage of the knife opposite the counterblade, being equal to an operating clearance, called the cutting size. For each knife (3, 4, 5, 6) and for at least one direction of rotation of the rotor, at least two non-aligned counterblades (7 and 11, 8 and 12, 9 and 13, 10 and 14) associated with the knife are adapted so that the distance separating the leading edge (45) of the knife and the leading edge (48, 56) of a counterblade at the moment when the leading edge of the knife opposes the leading edge of the counterblade, is different from one counterblade (7-10) to another (11-14).

The invention relates to a waste comminuting device, for the purpose of recycling said waste, for example. It applies advantageously, but not exclusively, to the comminuting of motor vehicle tires or other waste, incorporating materials of different types and properties (waste combining polymeric materials and metallic materials, for example) which have to be ultimately separated after the comminution.

Comminuting devices are known, comprising:

a comminuting housing receiving the waste to be comminuted,

a rotor which extends principally inside said housing and is provided with a plurality of protruding peripheral knives,

at least two stationary counterblades, not aligned in a longitudinal direction of the rotor, supported by the comminuting housing and designed to cooperate with the knives so as to comminute the waste. The presence of at least two counterblades (instead of one) has the result of multiplying the number of cuts performed with each rotation of the rotor.

Throughout the description, the terms “leading edge of a knife” conventionally denote the first protruding edge of said knife which passes opposite one (or each) associated counterblade during the rotation of the rotor (the term “associated” denoting a counterblade with which said knife cooperates). The terms “trailing edge of a knife” denote the last protruding edge of said knife which passes opposite one (or each) associated counterblade during the rotation of the rotor. Similarly, the terms “leading edge of a counterblade” denote the first protruding edge of said counterblade opposite which an associated knife passes during the rotation of the rotor. The terms “trailing edge of a counterblade” denote the last protruding edge of said counterblade opposite which an associated knife passes during the rotation of the rotor. It is noteworthy that the leading or trailing edges correspond respectively to specific edges of the knife or of the counterblade in a given rotational direction of the rotor, and that they correspond respectively with other edges in the other rotational direction. Moreover, by “shearing face of a knife or a counterblade” is understood the face of said knife or of said counterblade which extends between its leading edge and its trailing edge.

U.S. Pat. No. 4,706,899 discloses a comminuting device as defined above, called a granulator, of which the knives have shearing faces which extend over a single cylinder, called the cutting cylinder, of circular section centered on the rotational axis of the rotor. Said comminuting device only functions in one given rotational direction of the rotor. Each counterblade has, moreover, a leading edge located on the cutting cylinder, excluding operating clearance, and a shearing face which is radially remote from the cutting cylinder, from the leading edge of the counterblade to its trailing edge. When the leading edge of a knife opposes the leading edge of a counterblade, the distance, called the distance of attack, between these leading edges is thus the same whatever the counterblade in question (this distance is equal to the aforementioned operating clearance). Similarly, the angle called the angle of attack, which the shearing faces of a knife and a counterblade form at the moment when the leading edge of the knife opposes the leading edge of the counterblade, is the same whatever the counterblade in question. EP 536 634 discloses a similar granulator.

U.S. Pat. No. 5,775,608 discloses a further device as defined above, also called a granulator, which comprises two stationary counterblades and two series of knives. Each knife comprises two identical blades, symmetrical relative to a longitudinal median plane of the rotor. The leading and trailing edges of all the blades of the device are located on one cylinder, called the cutting cylinder, of circular section and centered on the axis of rotation of the rotor. The counterblades are centered on the same longitudinal median plane of the rotor (the plane passing through the axis of the rotor) and each have two cutting edges and a shearing face which are symmetrical relative to this plane; said cutting edges are located on the cutting cylinder, excluding operating clearance. The device is thus reversible and its operation is identical in both directions of rotation of the rotor. Similar to the device of EP 536 634, when the first blade of a knife opposes a counterblade, the angle of attack and the distance of attack are respectively the same whatever the counterblade in question. This observation also applies when the second blade of the knife (whose presence is only dictated by the desire to have a reversible comminuter and not by the desire to perform an additional cut) opposes a counterblade. The reversibility of the comminuting device makes it possible to halve the number and the frequency of maintenance operations for the purpose of sharpening the worn knives and thus to reduce the stoppage time of the device.

These two devices of the prior art, called granulators, reduce the waste into granulate by performing straight cuts, with each passage of a knife in front of a counterblade as soon as the leading edge of the knife opposes the leading edge of the counterblade.

The inventors have established that such devices have limits in certain applications and, in particular, when the waste to be comminuted is composed of a plurality of materials, of different types, shape and properties. The results in terms of comminuting and separating the materials are, in particular, unsatisfactory when the waste consists of a mixture of elastomers (rubber, for example), textile fibers and metal wires. This is the case of motor vehicle tires.

The inventors have also established that it could be useful to have multifunction comminuting devices, i.e. providing a plurality of types of comminution. Until now, such devices have not existed.

The invention aims to remedy these drawbacks, by proposing a multifunction comminuting device, which provides a plurality of types of comminution and is, as a result, capable of reducing in a satisfactory manner varied and mixed waste. The invention also consists in proposing for the first time a comminuting method in which the waste is subjected to a plurality of types of comminution within one and the same device.

In a preferred embodiment, a further object of the invention is to provide a “3 in 1” comminuting device which is able to be used according to three different modes, depending on the waste to be comminuted and subsequent treatments to which the comminuted waste has to be subjected.

The invention further aims to achieve all these objects at low cost, by providing a device of simple design and of cost price which is lower or equivalent to the devices of the prior art. The invention also aims to provide a device requiring simple and reduced maintenance.

To achieve this, the invention relates to a waste comminuting device comprising:

a comminuting housing receiving the waste to be comminuted,

a rotor, which extends principally inside said comminuting housing in a direction called the longitudinal direction, is rotatably mounted about its axis and comprises a plurality of protruding peripheral knives,

stationary counterblades supported by the comminuting housing, each knife being designed to cooperate with at least one counterblade so as to comminute the waste, the minimal distance separating each knife from each associated counterblade, during the passage of said knife opposite said counterblade, being equal to an operating clearance, called the cutting size, making it possible to reduce the waste to a desired size. It is noteworthy that each counterblade may cooperate with a plurality of knives, and in particular with knives distributed over the periphery of the same section (divided in the longitudinal direction) of the rotor.

The device according to the invention is characterized in that for each knife and for at least one direction of rotation of the rotor, called the primary direction of operation, at least two counterblades associated with said knife and not aligned in the longitudinal direction, are adapted so that the distance, called the distance of attack, which separates the leading edge of the knife and the leading edge of a counterblade, at the moment when the leading edge of said knife opposes the leading edge of said counterblade is different from one counterblade to another. For example, the shape of said counterblades and their arrangement within the comminuting device are such that said distance of attack is different from one counterblade to another.

The invention extends to a method for comminuting waste, wherein:
a device is used comprising:
   a comminuting housing,
   a rotor, which extends principally inside said comminuting housing in a direction called the longitudinal direction, is rotatably mounted about its axis and comprises a plurality of protruding peripheral knives,
   stationary counterblades supported by the comminuting housing, each knife being designed to cooperate with at least one counterblade so as to comminute the waste, the minimal distance separating each knife from each associated counterblade, during the passage of said knife opposite said counterblade, being equal to an operating clearance, called the cutting size, making it possible to reduce the waste to a desired size,
the waste is introduced into the comminuting housing.

The method according to the invention is characterized in that the waste is subjected, within the same comminuting device, to at least one first type of comminution, between at least one knife and at least one counterblade, and to a second type of comminution, between at least one knife and at least one further counterblade, the device comprising, for each knife and for at least one direction of rotation of the rotor, called the primary direction of operation, at least two counterblades associated with said knife and not aligned in the longitudinal direction, designed so that the distance, called the distance of attack, which separates the leading edge of the knife and the leading edge of a counterblade at the moment when the leading edge of said knife opposes the leading edge of said counterblade, is different from one counterblade to another.

Advantageously and according to the invention, for each knife and at least for the primary direction of operation, at least two counterblades associated with said knife—and not aligned in the longitudinal direction—are adapted so that the angle of attack between said knife and a counterblade is different from one counterblade to another.

In a preferred embodiment:

the (limited) paths in every straight section, of the leading edge and trailing edge of each knife of said straight section (i.e. of each of the knives “intersected” by said straight section) are located on the same circle, called the cutting circle, centered on the rotational axis of the rotor; moreover, the path in each straight section, of the shearing face of each knife of said straight section is preferably rectilinear;

for each knife, the device comprises at least one counterblade, called the grinding counterblade, associated with said knife (and which may be the same for a plurality of knives) which has a trailing edge of which the path in every straight section (intersecting said knife and as a result said grinding counterblade) is located on the cutting circle, excluding the cutting size; moreover, the path in every straight section (intersecting said knife and as a result said grinding counterblade) of the shearing face of said grinding counterblade radially approaches the cutting circle from its leading edge to its trailing edge. For one grinding counterblade, the distance of attack is thus (strictly) greater than the cutting size. When the knife passes opposite said grinding counterblade, the waste is trapped and driven between the knife and the grinding counterblade as soon as the leading edge of the knife opposes the leading edge of the grinding counterblade; this waste is then rolled and/or ground down and/or stretched and/or scraped between the knife and the counterblade until the leading edge of the knife opposes the trailing edge of the grinding counterblade; at this precise moment, a first cut is performed; then the waste is rolled and/or ground down further until the trailing edge of the knife opposes the trailing edge of the grinding counterblade, the moment where they undergo a second cut. The waste is thus subjected, between a knife and such a grinding counterblade, to a first type of comminution called grinding;

for each knife, the device comprises at least one further counterblade, called the granulating counterblade, associated with said knife (and which may be the same for a plurality of knives) which has a leading edge of which the path in every straight section (intersecting said knife and as a result said granulating counterblade) is located on the cutting circle, excluding the cutting size; in other words, the distance of attack which, by definition, separates the leading edges of said knife and said granulating counterblade at the moment where the leading edge of the knife opposes the leading edge of the counterblade, is equal to the cutting size (i.e. to the minimal distance separating these edges during the passage of the knife opposite the counterblade); moreover, the path in every straight section (intersecting said knife and as a result said granulating counter blade) of the shearing face of said granulating counterblade is radially remote from the cutting circle, from its leading edge to its trailing edge. When the knife passes opposite said granulating counterblade, a first straight cut is performed as soon as the leading edge of the knife opposes the leading edge of the granulating counterblade; then a second cut is possibly carried out on the waste potentially present between the knife and the granulating counterblade, at the moment when the trailing edge of the knife opposes the leading edge of said granulating counterblade (the distance separating said two edges thus being equal to the cutting size). The waste is thus subjected, between a knife and such a granulating counterblade, to a second type of comminution called granulation.

The invention extends to a method in which the waste is subjected to at least one first type of comminution called grinding and to a second type of comminution called granulation, by using a device as defined above. It is noteworthy that, according to the invention, the waste may be subjected in the first instance to a grinding action, then to a granulating action, or vice versa (in other words, the expressions “first type” and “second type” do not refer to the order in which the waste is subjected to the two types of comminution). It is also noteworthy that the waste undergoes a plurality of granulating actions and/or a plurality of grinding actions before being discharged from the device, and that some waste which is initially very fine may be discharged having only undergone one of the types of comminution to which it is to be subjected.

Advantageously and according to the invention:

the comminuting housing comprises, on the one hand, two lateral longitudinal walls parallel to the axis of the rotor and, on the other hand, a feed hopper extending in the upper part of the housing, above the rotor, and via which the waste may be introduced,

the comminuting device comprises a series of counterblades aligned in the longitudinal direction along one of said lateral longitudinal walls and a further series of counterblades aligned in the longitudinal direction along the other lateral longitudinal wall, the counterblades of the two series extending above a longitudinal median plane passing through the axis of the rotor; in a preferred embodiment, the aforementioned median plane is horizontal; the shearing face of each counterblade (of each series) extends preferably at right angles to said median plane, i.e. vertically in the preferred embodiment; the counterblades of the two series are preferably equidistant from this median plane,

the comminuting device comprises a screen extending between the two series of counterblades below the rotor.

Thus, whatever the direction of rotation of the rotor, the first counterblade encountered at the entrance to the screen by a knife previously located in one zone, called the feed zone, extending between the feed hopper, the rotor and the series of counterblades, is a grinding counterblade as defined above. In contrast, the other counterblade encountered by this knife at the outlet of the screen, is a granulating counterblade. Whatever the direction of rotation of the rotor, the waste coming from the feed zone thus undergoes in the first instance a rolling action, then a cutting action (in the region of the first counterblade). The waste thus rolled and comminuted is then driven by the rotor into a zone, called the screening zone, extending between the rotor, the series of counterblades and the screen, pressed against the screen by the knives. If its size is smaller than the size of the mesh of the screen, it passes through the screen to be discharged through a hopper called the discharge hopper. If the size of the waste is larger than the size of the mesh of the screen, said waste is transported by the rotor to the second counterblade, where it is subjected to a straight cut reducing it to granulate. This waste then passes through the screen (only if its size permits) and/or is again driven into the feed zone, then into the screening zone. During the passage of the grinding counterblade, it is possibly subjected to a second rolling and cutting action.

Advantageously and according to the invention, each counterblade is removably mounted in the comminuting housing, such that it is possible, for each knife, to remove at least one counterblade associated with said knife. Thus, the invention provides a “3 in 1” multifunction comminuting device:

when the assembly of the granulating counterblade(s) is removed, and the device is thus only equipped with grinding counterblade(s), the waste is systematically rolled and/or ground down before being cut into sections; the device thus operates in grinding mode; it is described as a grinder; this operating mode is particularly efficient in the case of complex waste combining a plurality of materials, in that it facilitates the separation of these materials;

when the assembly of grinding counterblade(s) is removed and the device is only equipped with granulating counterblade(s), the waste is subjected to straight cuts which reduces it to small-sized granulate; the device thus operates in granulating mode; it is described as a granulator; this operating mode makes it possible to obtain finely cut-up and relatively uniform waste;

when no counterblade is removed or the device is equipped with at least one grinding counterblade and with at least one granulating counterblade for each knife, the device provides two types of comminution; it then operates in grinding/granulating mode; it is described as a grinder/granulator; this operating mode combines the advantages of the two preceding modes.

In a preferred embodiment where each counterblade is designed to be able to be mounted in the comminuting housing from the outside of said housing, through an aperture passing through the housing, called the mounting aperture, the comminuting device according to the invention advantageously comprises a set of wedges comprising, for each knife, at least one wedge designed to be able to be mounted instead of a counterblade associated with said knife and to be able to seal the mounting aperture of said counterblade (the same wedge thus able to be associated with a plurality of knives), said wedge having dimensions designed to be able to extend at a distance from the knives so as not to cooperate with said knives.

Advantageously and according to the invention, all the counterblades of the comminuting device are identical.

The invention also relates to a device and a method for comminution, characterized in combination by all or part of the features mentioned above and below.

Further objects, features and advantages of the invention will appear from reading the following description which refers to the accompanying figures representing a preferred embodiment of the invention, given solely by way of non-limiting example.

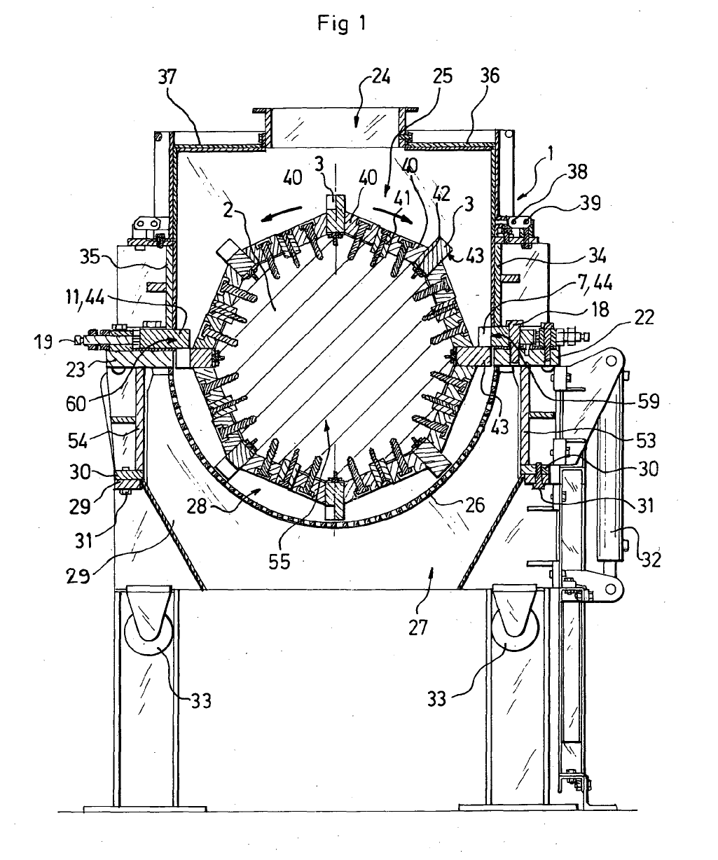

FIG. 1 is a schematic view of a comminuting device according to the invention in section along two transverse half-planes A and B.

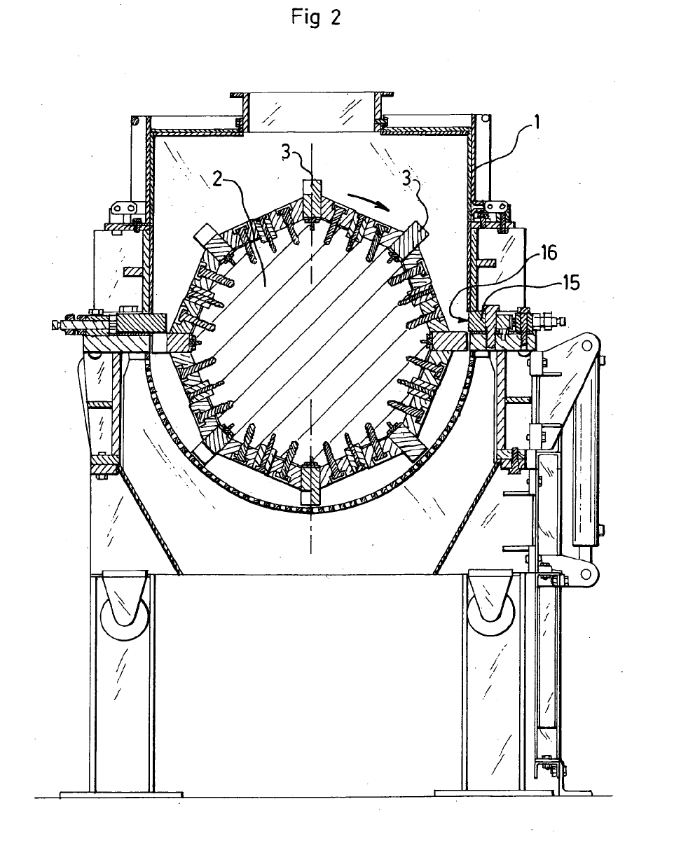

FIG. 2 is a schematic view, in section along said planes A and B, of the comminuting device of FIG. 1, in which a series of counterblades has been replaced by a series of wedges.

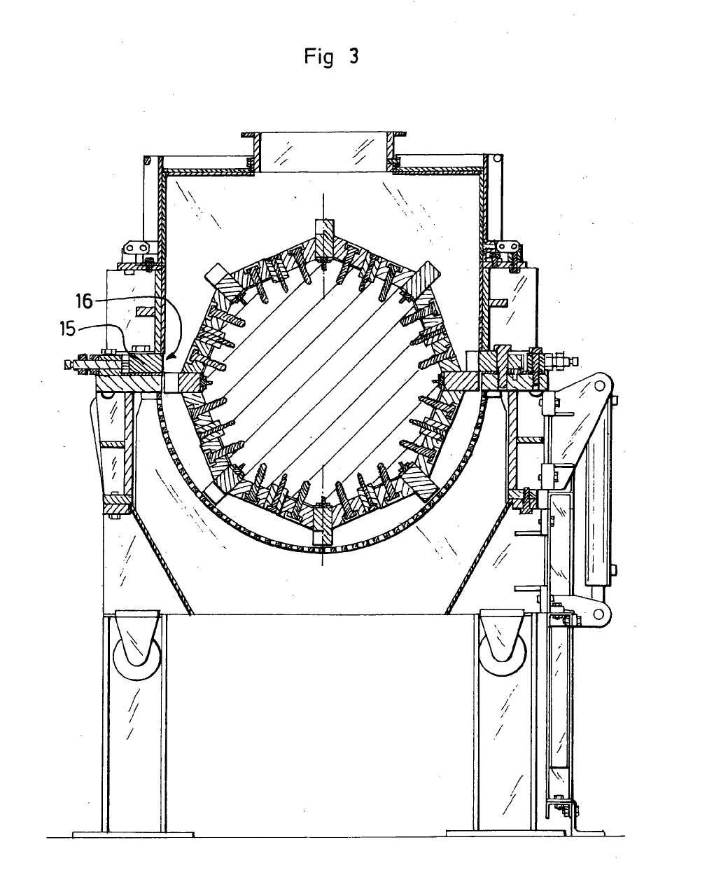

FIG. 3 is a schematic view in section along said planes A and B, of the comminuting device of FIGS. 1 and 2, in which a further series of counterblades has been replaced by a series of wedges.

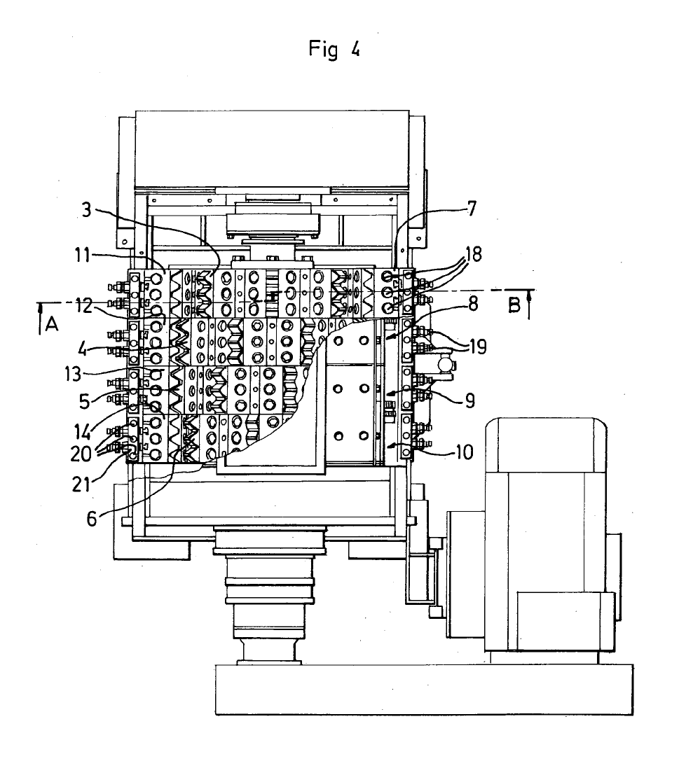

FIG. 4 is a plan view of the comminuting device of FIGS. 1 to 3, of which one part of the comminuting housing has been broken away.

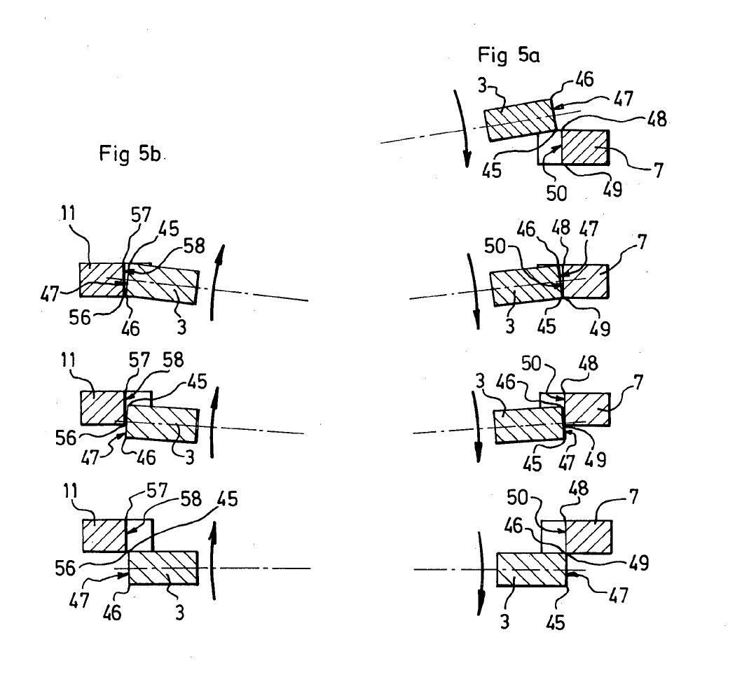

FIG. 5a is a diagram illustrating the relative position during the rotation of the rotor, of a knife and a grinding counterblade associated with said knife.

FIG. 5b is a diagram illustrating the relative position, during the rotation of the rotor, of a knife and a granulating counterblade associated with said knife.

The comminuting device illustrated in FIGS. 1 to 5 comprises a comminuting housing 1, inside which is arranged a rotor 2. The axis of the rotor 2 extends in a horizontal direction defining a longitudinal direction of the housing. The horizontal direction at right angles to the longitudinal direction is called the transverse direction.

The comminuting housing comprises, in particular, four feet, two end walls 51, 52 at right angles to the rotor, and two lateral longitudinal walls parallel to the rotor, formed by two substructures 53, 54 resting on the feet, two lateral girders 22, 23 supported by the substructures, two sides 34, 35 extending above the lateral girders 53, 54 and a vertical portion of two upper hatches 36, 37, said hatches permitting access to the inside of the comminuting housing above the rotor. The comminuting housing also comprises an upper feed hopper 24 and a cradle 29 forming a lower discharge hopper 27. This cradle 29 supports, moreover, a screen 26 which extends below the rotor between the lateral girders 22 and 23.

The rotor comprises a solid rotating drive shaft 55, a plurality of knives 3, 4, 5, 6, 7 arranged about this shaft and a plurality of fixing plates 41 and locking wedges 40. In the example illustrated, the drive shaft is cylindrical and its cross section has eight large faces and eight small faces, the large and small faces being alternated. The rotor comprises four rows of eight knives distributed around the rotor. The rows of knives are successive in the longitudinal direction. The knives of two successive rows are offset at an angle in this direction, so as to form eight helixes about the axis of the rotor. Each knife 3 is arranged on one small face of the drive shaft 55. Its position is adjusted radially by means of screws 42 against which the knife bears. A fixing plate 41 is fixed to the drive shaft on each large face thereof, between two successive knives, by screws extending radially. For each knife 3, a locking wedge 40 is inserted and fixed to the shaft (by screws extending radially) between a fixing plate 41 and said knife on one side thereof. A further locking wedge 40 is then pushed in and fixed to the shaft (by screws extending radially) between the knife and the fixing plate 41 located on the other side of said knife. Each knife 3 is thus trapped in the operating position between two locking wedges 40, each wedge resting on a fixing plate 41.

The comminuting device comprises, moreover, a first series of four counterblades 7 to 10, aligned in the longitudinal direction and a second series of four counterblades 11 to 14, aligned in the longitudinal direction. Each series of counterblades extends in the longitudinal direction. The counterblades 7 to 10 of the first series are supported by the lateral girder 22 of the comminuting housing; the counterblades 11 to 14 of the second series are supported by the lateral girder 23. Each counterblade is arranged so as to extend opposite a row of knives in the transverse direction. Thus the counterblades 7 and 11 cooperate with the row of knives 3; the counterblades 8 and 12 cooperate with the row of knives 4; the counterblades 9 and 13 cooperate with the row of knives 5; and the counterblades 10 and 14 cooperate with the row of knives 6. It is noteworthy that the knives and counterblades have lengths (dimensions in the longitudinal direction) which are equal.

The knives and counterblades respectively have comminuting teeth 43 and 44, the comminuting teeth 43 of each knife interlocking between the comminuting teeth 44 of a counterblade when said knife passes opposite said counterblade. Each counterblade is arranged such that the minimal distance between its teeth and those of each knife with which it cooperates, is equal to an operating clearance, called the cutting size. To this end, each counterblade is inserted into the comminuting housing from the outside of said housing through a mounting aperture 59 (for the counterblades 7 to 10) or 60 (for the counterblades 11 to 14) then fixed to one of the lateral girders 22 (for the counterblades 7 to 10) or 23 (for the counterblades 11 to 14) by a plurality (three in the example illustrated) of fixing screws 18 extending vertically and each passing through a bore of the counterblade. Said bore has a dimension in the transverse direction which is slightly greater than the diameter of the screw. Thus, the position of the counterblade in the transverse direction may be adjusted. This adjustment is carried out by means of at least one adjustment system (in the example illustrated) comprising two concentric screws 19, one central, the other peripheral, which extend in the transverse direction opposite a lateral face of the counterblade: the central screw, anchored in the counterblade, makes it possible to displace the counterblade to the exterior of the comminuting housing; the peripheral screw bearing on the lateral face of the counterblade, makes it possible to displace the counterblade to the inside of the comminuting housing, the combination of the two concentric screws guaranteeing a precise positioning and a rigid support of the counterblade in the transverse direction. It is noteworthy that each adjusting system also comprises a plate 20 for supporting concentric screws 19, which plate is fixed to the corresponding lateral girder 22, 23 by screws 21. Once the adjustment has been carried out, the fixing screws 18 are tightened to maintain the counterblade firmly in its operating position. By way of example, when the device is intended to comminute motor vehicle tires, the counterblades are positioned so that the cutting size is between 0.5 and 1.5 mm.

The waste is introduced through the feed hopper 24 into a zone 25 of the housing, called the feed zone, located above the rotor between the feed hopper 24, the hatches 36 and 37, the rotor 2, the counterblades 7 to 10 and the counterblades 11 to 14. The zone of the housing extending below the rotor between the counterblades 7 to 10, the rotor 2, the counterblades 11 to 14 and the screen 26 is called the screening zone.

In the example illustrated, the direction of rotation of the rotor called the primary direction of operation corresponds to the clockwise direction (or reverse trigonometric direction). The teeth of each knife extend, in a tangential direction (on a circle linking the knives), between two edges 45, 46. The edge 45 is called the leading edge: it corresponds to the first of the two edges (defining the teeth of the knife) which passes over any reference radius, and for example opposite a counterblade, during a rotation of the rotor in the primary direction of operation. The edge 46 is called the trailing edge: it corresponds to the last of said edges which passes over the reference radius (or opposite the counterblade) during a rotation of the rotor in the primary direction of operation. The shearing face 47 of the knife which extends between its leading and trailing edges, forms the teeth 43; it has a rectilinear path in every straight section of the rotor. In every straight section, the paths of the leading and trailing edges of the knives 3 (or 4 or 5 or 6) intersected by the section (these knives thus belonging to the same row of knives) are located on the same circle, called the cutting circle, centered on the axis of the rotor.

The rotor is arranged such that the horizontal median plane passing through the axis of said rotor coincides with the median plane of symmetry of the girders 22 and 23. The counterblades 7 to 10 and 11 to 14 thus extend above the horizontal median plane of the rotor.

The teeth 44 of each counterblade 7 to 10 extend vertically between an edge 48 and an edge 49 of the counterblade; the edge 48 is called the leading edge as it corresponds to the first edge of the counterblade which a knife encounters during a rotation of the rotor in the primary direction of operation; the edge 49 is called the trailing edge as it corresponds to the last edge of the counterblade which a knife encounters during a rotation of the rotor in the primary direction of operation. The shearing face 50 of each counterblade 7 to 10 which links the leading edge 48 and trailing edge 49, extends vertically and, as a result, radially approaches the axis of the rotor from the leading edge to the trailing edge. Each counterblade 7 to 10, called the grinding counterblade, is arranged such that the distance which separates a knife from said counterblade when the leading edge of the knife is opposite the trailing edge of the counterblade is equal to the cutting size. In other words, the (limited) path in every straight section of the trailing edge of each grinding counterblade 7 to 10 is located on the cutting circle, excluding the cutting size.

Similarly, the teeth 44 of each counterblade 11 to 14, extend vertically between an edge 56 and an edge 57 of the counterblade; the edge 56 is called the leading edge as it corresponds to the first edge of the counterblade which a knife encounters during a rotation of the rotor in the primary direction of operation; the edge 57 is called the trailing edge as it corresponds to the last edge of the counterblade which a knife encounters during a rotation of the rotor in the primary direction of operation. The shearing face 58 of each counterblade 11 to 14, which connects the leading edge 56 and trailing edge 57 extends vertically and as a result moves radially away from the axis of the rotor from the leading edge to the trailing edge. Each counterblade 11 to 14, called the granulating counterblade, is arranged such that the distance (of attack) which separates a knife from said counterblade when the leading edge of the knife is opposite the leading edge of the counterblade is equal to the cutting size. In other words, the (limited) path in every straight section of the leading edge of each granulating counterblade 11 to 14, is located on the cutting circle, excluding the cutting size.

When a knife 3 arrives, in a radial direction passing through the leading edge of the knife, opposite the grinding counterblade 7 (see also FIG. 5a) the leading edge 45 of the knife is at a distance from the leading edge 48 of the counterblade. The waste is driven in rotation and crushed between the shearing faces 47 and 50 of the knife and of the counterblade, until the leading edge 45 of the knife opposes the trailing edge 49 of the counterblade, where it is subjected to a first cut. The waste trapped between the two shearing faces 47, 50 is finely ground down until the trailing edge 46 of the knife opposes the trailing edge 49 of the counterblade, where it is subjected to a second cut.

When a knife 3 opposes, in a radial direction passing through the leading edge of the knife, the granulating counterblade 11 (see also FIG. 5b), the leading edge 45 of the knife and the leading edge 56 of the counterblade are separated at a distance equal to the cutting size. The waste is then subjected to a first straight cut, possibly followed by a second cut when the trailing edge 46 of the knife opposes the leading edge 56 of the counterblade.

The waste thus undergoes two types of comminution: a comminution called grinding, by rolling, grinding down and cutting, which efficiently separates the different materials present (for example rubber and the metal wires of the tires of the vehicle) and a comminution by straight cutting, called granulation, which produces fine granulate. This double comminution provides the device according to the invention with a greater efficiency than that of the known devices of the prior art.

FIG. 2 illustrates the device of FIG. 1, in which the series of counterblades 7 to 10 has been removed and replaced by a set of wedges 15. The wedges 15 are introduced through the mounting aperture 59; they are fixed to the girder 22 and positioned in the transverse direction in the same manner as the counterblades 7 to 10; i.e. by means of fixing screws 18 and adjusting systems using concentric screws 19. The wedges 15 have a planar face 16 which, when the wedges are in the operating position, extends in the extension of the side 34, always at a distance from the knives so as to not cooperate with said knives. The waste is, as a result, comminuted only in the region of the counterblades 11 to 14. When the rotor rotates in the primary direction of operation, the comminuting device thus operates in a mode called granulating mode, in which the waste is only subjected to a single type of comminution, by straight cuts.

FIG. 3 illustrates the device of FIG. 1, in which the series of counterblades 11 to 14 has been removed and replaced by a set of wedges 15, as explained above. The wedges 15 are introduced through a mounting aperture 60, fixed to the girder 23 and positioned in the transverse direction in the same manner as the counterblades 11 to 14. As their planar face 16 always extends at a distance from the knives, the waste is only comminuted in the region of the counterblades 7 to 10. When the rotor rotates in the primary direction of operation, the comminuting device thus operates according to a mode, called the grinding mode, in which the waste is only subjected to a single type of comminution, by rolling and/or grinding down and cutting.

The invention thus provides a multifunction device which is suitable for all types of waste.

It is noteworthy that if said device has drive means capable of driving the rotor 2 in both rotational directions, the device may operate in grinding mode in the configuration illustrated in FIG. 2: to this end, it suffices to turn the rotor in the direction opposing the primary direction of operation, called the secondary direction of operation. In contrast, the comminuting device may operate in granulating mode in the configuration illustrated in FIG. 3 (when its rotor is driven in the secondary direction of operation). Depending on the selected direction of rotation, the same configuration makes it possible, therefore, to use the comminuting device in granulating mode or in grinding mode. Moreover, when the counterblades 7 to 10 and 11 to 14 are present (configuration illustrated in FIG. 1) the comminuting device may operate in either direction, with the same result. This makes it possible to halve the stoppage time of the device for maintenance purposes.

It is also noteworthy that, taking account of the symmetry of the parts and their arrangement, the counterblades 7 to 10 and 11 and 14 are all identical. The invention thus makes it possible to obtain a plurality of types of comminution from the same components. Moreover, for the same reasons, the same set of wedges may be used to replace the set of counterblades 7 to 10, or the set of counterblades 11 to 14. These two features above make it possible not only to reduce the costs of manufacture of the comminuting device but also to reduce the frequency of maintenance operations which are capable of immobilizing the device for a long time. For example, when a serious incident occurs on a grinding counterblade (of which the action is of primary importance) and no replacement counterblade is available, it is possible to replace the unusable grinding counterblade with one of the granulating counterblades of the device and to compensate for the absence thereof by a wedge. In the case of the illustrated device, of which the rotor may be driven in both directions, it is also possible to replace the unusable grinding counterblade by a wedge and to reverse the direction of rotation of the rotor.

It is also noteworthy that the counterblades 7 to 10 and 11 to 14 are also reversible: each counterblade may be mounted, at the same position, in either direction so as to reverse its leading and trailing edges. When the leading edge of a counterblade, used as a granulating counterblade, has a fault (wear, breakage, etc.) it suffices to rotate said counterblade to extend its use before a future sharpening operation, the defective edge thus becoming the trailing edge of the granulating counterblade (of which the action is of little importance relative to the leading edge).

The cradle 29 forming the discharge hopper 27 and supporting the screen 26 is equipped with at least three (four in the illustrated example) lower wheels 33. If they are fixedly mounted, these wheels 33 are oriented in the transverse direction (as a variant, they are mounted freely in rotation about a vertical axis). The cradle 29 is slidably mounted in the vertical direction between a position called the operating position and a position called the release position. To this end, it is coupled to guide rails 62. In the operating position, the cradle may be rigidly fixed to the comminuting housing; if required, it is fixed on each side of the comminuting housing to a lower girder 30 of the substructure 53, 54 by screws 31; moreover, the screen extends at a short distance from the rotating knives. In the release position, the wheels of the cradle rest on the ground and the cradle, in addition to the screen and the discharge hopper, extend entirely below the comminuting housing so as to be able to be removed from the device; in this release position, the cradle carrying the screen may roll on the ground in the transverse direction and be moved away from the comminuting housing, to permit access to the rotor from below, to replace the screen (for example with a screen having mesh of a different size) or to clean said screen. The displacement of the cradle between these two positions is carried out by means of an actuating cylinder 32. This arrangement makes it possible to have a comminuting device of low height, compared to the devices known from the prior art. It is thus no longer necessary to equip the device with safety platforms to permit access to the different parts of the device. This arrangement also makes it possible to facilitate maintenance operations of the cradle and the screen, and in particular operations for mounting and removing said screen and cradle relative to the comminuting device.

The comminuting device according to the invention comprises, moreover, a fixed feed hopper 24, whilst the devices known from the prior art have pivoting hoppers in order to permit access from the top to the inside of the comminuting housing and to the rotor. A pivoting hopper, such as the hoppers from the prior art, has the drawback of requiring the displacement of the conveyor belt for the waste leading to the hopper in order to allow the pivoting thereof. These operations are complex and lengthy. In the device according to the invention, the feed hopper 24 and the associated conveyor belt (not shown) are fixedly mounted; the access to the rotor from the top takes place via one of the hatches 36, 37 which facilitates considerably the maintenance operations. Each hatch 36, 37 comprises a vertical portion forming part of one of the lateral walls of the comminuting housing, and an upper horizontal portion forming part of an upper wall of the comminuting housing. These portions are rigidly fixed to one another. The vertical portion of the hatch 36 is pivotably mounted relative to the comminuting housing about two opposing longitudinal axes 38, 39 in the transverse direction, the axis 39 being fixed relative to the comminution housing, and the axis 38 being mounted pivotably about the axis 39. The upper horizontal portion of the hatch 36 is fixed to the feed hopper 24 by screws 61, which are accessible at the side from the outside of the housing. The hatch 37 is arranged in a similar manner on the other side of the comminuting housing. To access the rotor through the top, it suffices to remove the screws 61 and to swing the hatch 36 (or 37) about the pivot axis 38 and then the pivot axis 39.

It goes without saying that the invention may form the subject of numerous variants relative to the embodiment which is disclosed and illustrated.

In particular, it is possible for the granulating and grinding counterblades not to be identical. It is possible that these counterblades are not arranged parallel to the horizontal median plane of the rotor. It is also noteworthy that each series of (grinding or granulating) counterblades may be replaced by a single counterblade of long length.

Each knife may be associated with two counterblades arranged opposite one another on the same diameter of the rotor. It is noteworthy that in this case the shearing face of said counterblades may not extend tangentially to the cutting circle (except possibly if these two counterblades have different thicknesses, thus providing separate distances of attack from one counterblade to the other; a rolling and/or grinding down action is thus obtained for each counterblade, but to a different degree from one counterblade to another, resulting in noticeable results in terms of comminution).

Each knife may be associated with three counterblades, or even a greater number.

The path, in a straight section, of the shearing face of the knives and/or of the counterblades may be curved.

The shearing face of the knives and/or the counterblades may form with an adjacent face (in the region of the leading edge or the trailing edge of the knife or the counterblade) an angle greater or less than 90°.

1-13. (canceled)

14. A waste comminuting device comprising:
a comminuting housing receiving the comminuted,
a rotor, which extends principally inside said comminuting housing in a direction called the longitudinal direction, is rotatably mounted about its axis and comprises a plurality of protruding peripheral knives,
stationary counterblades supported by the comminuting housing, each knife being designed to cooperate with at least one counterblade so as to comminute the waste, the minimal distance separating each knife from each associated counterblade, during the passage of said knife opposite said counterblade, being equal to an operating clearance, called the cutting size, making it possible to reduce the waste to a desired size,
wherein for each knife and for at least one direction of rotation of the rotor, called the primary direction of operation, at least two counterblades associated with said knife and not aligned in the longitudinal direction, are adapted so that the distance, called the distance of attack, which separates an edge of the knife, called the leading edge of the knife, and an edge of a counterblade, called the leading edge of the counterblade, at the moment when the leading edge of said knife opposes the leading edge of said counterblade is different from one counterblade to another, the leading edge of the knife corresponding to the first protruding edge of said knife which passes opposite an associated counterblade during rotation of the rotor, the leading edge of a counterblade corresponding to the first protruding edge of said counterblade opposite which an associated knife passes during a rotation of the rotor.

15. The device as claimed in claim 14, wherein for each knife and at least for the primary direction of operation, at least two counterblades which are not aligned and associated with said knife are designed so that the angle, called the angle of attack, which one face of the knife forms, called the shearing face of the knife, and one face of a counterblade, called the shearing face of the counterblade, at the moment when the leading edge of the knife opposes the leading edge of the counterblade, is different from one counterblade to another, the shearing face of a knife corresponding to the face of said knife which extends between its leading and trailing edges, the trailing edge of the knife corresponding to the last protruding edge of said knife which passes opposite an associated counterblade during the rotation of the rotor, the shearing face of a counterblade corresponding to the face of said counterblade which extends between its leading and trailing edges, and the trailing edge of the counterblade corresponding to the last protruding edge of said counterblade, opposite which an associated knife passes during the rotation of the rotor.

16. The device as claimed in claim 14, wherein:
the paths, in every straight section, of the leading edge and trailing edge of each knife of the section are located on the same circle, called the cutting circle, centered on the rotational axis of the rotor,
for each knife, the device comprises at least one counterblade, called the grinding counterblade, associated with said knife, which has a trailing edge of which the path, in every straight section, is located on the cutting circle, excluding the cutting size, the path in every straight section of the shearing face of said grinding counterblade radially approaching the cutting circle from its leading edge to its trailing edge,
for each knife, the device comprises at least one further counterblade, called the granulating counterblade, associated with said knife, which has a leading edge of which the path, in every straight section, is located on the cutting circle, excluding the cutting size, the path in every straight section of the shearing face of said granulating counterblade being radially remote from the cutting circle, from its leading edge to its trailing edge.

17. The device as claimed in claim 14, wherein:
the comminuting housing comprises two lateral longitudinal walls parallel to the axis of the rotor,
the comminuting device comprises a series of counterblades aligned in the longitudinal direction along one of said lateral longitudinal walls and a further series of counterblades aligned in the longitudinal direction along the other lateral longitudinal wall, the counterblades of the two series extending above a longitudinal median plane passing through the axis of the rotor, the shearing face of each counterblade extending at right angles to said median plane.

18. The device as claimed in claim 17, wherein said median plane is horizontal, the shearing face of each counterblade extending vertically.

19. The device as claimed in claim 14, wherein each counterblade is removably mounted in the comminuting housing.

20. The device as claimed in claim 19, wherein:
each counterblade is designed to be able to be mounted in the comminuting housing from the outside of said housing, through an aperture passing through the housing, called the mounting aperture,
the comminuting device according to the invention advantageously comprises a set of wedges comprising, for each knife, at least one wedge designed to be able to be mounted instead of a counterblade associated with said knife and to be able to seal the mounting aperture of said counterblade, said wedge having dimensions designed to be able to extend at a distance from the knives so as not to cooperate with said knives.

21. The device as claimed in claim 14, wherein all the counterblades thereof are identical.

22. The device as claimed in claim 14, wherein it comprises a cradle supporting both a screen (26) and a hopper called the discharge hopper, and wherein this cradle is slidably mounted in a vertical direction between a position called the operating position in which the cradle may be rigidly fixed to the comminuting housing and the screen extends at a short distance from the rotating knives, and a position called a release position, in which the cradle in addition to the screen and the discharge hopper which it supports, extend entirely below the comminuting housing so as to be able to be removed from the device.

23. The device as claimed in claim 22, wherein the cradle is provided with at least three lower wheels.

24. The device as claimed in claim 14, wherein the comminuting housing comprises a hopper, called the feed hopper, extending in the upper part of said housing, above the rotor, wherein said feed hopper is fixedly mounted, and in that the comminuting housing comprises at least one upper hatch for access to the interior of the comminuting housing above the rotor.

25. A method for comminuting waste, wherein:
a device is used comprising:
a comminuting housing,
a rotor, which extends principally inside said comminuting housing in a direction called the longitudinal direction, is rotatably mounted about its axis and comprises a plurality of protruding peripheral knives,
stationary counterblades supported by the comminuting housing, each knife being designed to cooperate with at least one counterblade so as to comminute the waste, the minimal distance separating each knife from each associated counterblade, during the passage of said knife opposite said counterblade, being equal to an operating clearance, called the cutting size, making it possible to reduce the waste to a desired size,
the waste is introduced into the comminuting housing, wherein the waste is subjected, within the same comminuting device, to at least one first type of comminution, between at least one knife and at least one counterblade, and to a second type of comminution, between at least one knife and at least one further counterblade, the device comprising, for each knife and for at least one direction of rotation of the rotor, called the primary direction of operation, at least two counterblades associated with said knife and not aligned in the longitudinal direction, adapted so that the distance, called the distance of attack, which separates an edge of the knife, called the leading edge of the knife, and an edge of a counterblade, called the leading edge of the counterblade, at the moment when the leading edge of said knife opposes the leading edge of said counterblade, is different from one counterblade to another, the leading edge of the knife corresponding to the first protruding edge of said knife which passes opposite an associated counterblade during the rotation of the rotor, and the leading edge of a counterblade corresponding to the first protruding edge of said counterblade opposite which an associated knife passes during a rotation of the rotor.

26. The method as claimed in claim 25, wherein the waste is subjected at least to a first type of comminution called grinding and to a second type of comminution called granulation, by using a device in which:
the paths, in every straight section, of the leading edge and trailing edge of each knife of the section are located on the same circle, called the cutting circle, centered on the rotational axis of the rotor,
for each knife, the device comprises at least one counterblade, called the grinding counterblade, associated with said knife, which has a trailing edge of which the path in every straight section is located on the cutting circle, excluding the cutting size, the path in every straight section of the shearing face of said grinding counterblade radially approaching the cutting circle from its leading edge to its trailing edge.
for each knife, the device comprises at least one further counterblade, called the granulating counterblade, associated with said knife, which has a leading edge of which the path in every straight section is located on the cutting circle, excluding the cutting size, the path in every straight section of the shearing face of said granulating counterblade being radially remote from the cutting circle, from its leading edge to its trailing edge.

27. The device as claimed in claim 15, wherein:
the paths, in every straight section, of the leading edge and trailing edge of each knife of the section are located on the same circle, called the cutting circle, centered on the rotational axis of the rotor,
for each knife, the device comprises at least one counterblade, called the grinding counterblade, associated with said knife, which has a trailing edge of which the path, in every straight section, is located on the cutting circle, excluding the cutting size, the path in every straight section of the shearing face of said grinding counterblade radially approaching the cutting circle from its leading edge to its trailing edge,
for each knife, the device comprises at least one further counterblade, called the granulating counterblade, associated with said knife, which has a leading edge of which the path, in every straight section, is located on the cutting circle, excluding the cutting size, the path in every straight section of the shearing face of said granulating counterblade being radially remote from the cutting circle, from its leading edge to its trailing edge.

28. The device as claimed in claim 15, wherein:
the comminuting housing comprises two lateral longitudinal walls parallel to the axis of the rotor,
the comminuting device comprises a series of counterblades aligned in the longitudinal direction along one of said lateral longitudinal walls and a further series of counterblades aligned in the longitudinal direction along the other lateral longitudinal wall, the counterblades of the two series extending above a longitudinal median plane passing through the axis of the rotor, the shearing face of each counterblade extending at right angles to said median plane.

29. The device as claimed in claim 16, wherein:
the comminuting housing comprises two lateral longitudinal walls parallel to the axis of the rotor,
the comminuting device comprises a series of counterblades aligned in the longitudinal direction along one of said lateral longitudinal walls and a further series of counterblades aligned in the longitudinal direction along the other lateral longitudinal wall, the counterblades of the two series extending above a longitudinal median plane passing through the axis of the rotor, the shearing face of each counterblade extending at right angles to said median plane.

30. The device as claimed in claim 15, wherein each counterblade is removably mounted in the comminuting housing.

31. The device as claimed in claim 16, wherein each counterblade is removably mounted in the comminuting housing.

32. The device as claimed in claim 17, wherein each counterblade is removably mounted in the comminuting housing.

33. The device as claimed in claim 18, wherein each counterblade is removably mounted in the comminuting housing.
